(19) United States
(12) Patent Application Publication
(10) Pub. No.: US 2007/0048723 A1
(43) Pub. Date: Mar. 1, 2007

(54) SECURELY ADMINISTERING COMPUTERIZED TESTS OVER A NETWORK

(75) Inventors: John Lane Brewer, Orem, UT (US); David F. Foster, Lindon, UT (US); Dennis Maynes, Pleasant Grove, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: CAVEON, LLC, Draper, UT (US)

(21) Appl. No.: 11/465,070

(22) Filed: Aug. 16, 2006

Related U.S. Application Data
(60) Provisional application No. 60/709,698, filed on Aug. 19, 2005.

(51) Int. Cl. G09B 3/00

(52) U.S. Cl. 434/350

(57) ABSTRACT

Embodiments of the present invention are directed to securely administering computerized tests over a network, such as, for example, the Internet. A method and system are provided for the delivery of computerized tests via the Internet with unique security features which reduce or eliminate the need for constant human observation of examinees and dedicated testing centers. The system makes test creation, publication, registration and delivery tools accessible to users via the Internet. Security features include real-time analysis of examinee test-response data and test event data for indications test-taker misconduct, authentication of examinee identity using biometric information, observation of examinee activity using real-time Internet-based audio and video data, and continuous or alert-based human proctoring and intervention via the Internet.

### CROSS-REFERENCE TO RELATED APPLICATIONS

The present application claims priority from U.S. provisional patent application Ser. No. 60/709,698, filed Aug. 19, 2005, and entitled “Securely Administering Computerized Tests Over A Network”, which provisional application is incorporated herein by reference in its entirety.

### BACKGROUND

1. Background and Relevant Technology

Computer systems and related technology affect many aspects of society. Indeed, the computer system's ability to process information has transformed the way we live and work.

The familiar process of administering standardized tests is no exception. Many standardized tests (e.g., GRE, LSAT, GMAT) are now administered on computers. Computers allow testing organizations to quickly distribute a test to large numbers of remote testing centers, and to deliver the test “on-demand.”

The administration of a computerized, standardized test typically includes an examinee or test-taker attending a dedicated, computerized testing facility (“testing center”). Testing centers typically use local computer networks to deliver tests to multiple test-takers, employing various test security measures to insure the integrity of any administered tests. For example, computer workstation booths are typically used to provide an element of physical test security, testing center personnel routinely confirm a test-taker's identity by checking official forms of identification, and proctors monitor each test event to detect and discourage cheating and theft of confidential test material (“test-taker misconduct”). Though familiar and usually effective, these test security measures demand significant human and financial resources to maintain the integrity of the testing process and to keep sensitive test material secure.

Thus, some attempts to automate test security measures have been developed to reduce the need for support personnel and facilities. At least one system includes one or more computerized testing stations and a central server or data center connected to a common computer network. Each computerized testing station integrates necessary software and hardware to provide a remote and completely unmanned test station. Accordingly, the computerized testing stations allow test-takers to register, schedule, and complete a test without the need for assistance. Each computer system interacts with the central server or data center to access test data (e.g., test questions) and send question response data (“response data”) and to compare received test registration and biometric data to stored test registration and biometric data. Each computerized testing station can also record and store audio and video information for subsequent review for possible misconduct.

Unfortunately, such a testing environment requires considerable resources to conduct later reviews of audio and video records for indications of test-taker misconduct, and further effort to corroborate those findings with other sources of evidence. Potentially more important, not all types of test-taker misconduct can be detected using audio, visual and biometric test surveillance (e.g., recall of memorized test content). Finally, because these reviews occur after a test event has concluded, the testing process cannot be altered, interrupted or stopped to prevent test-taker misconduct, the delivery of an unearned test score (and any associated credential), or the taking of confidential test material.

### BRIEF SUMMARY OF THE INVENTION

Embodiments of the present invention provide for securely administering computerized tests over a network, such as, for example, the Internet. Embodiments facilitate the delivery of computerized tests via the Internet with unique security features which reduce or eliminate the need for constant human observation of examinees and dedicated testing centers. The system makes test creation, publication, registration and delivery tools accessible to users via the Internet. Security features include real-time analysis of examinee test-response data and test event data (e.g., test response latencies) for indications test-taker misconduct, authentication of examinee identity using biometric information, observation of examinee activity using real-time Internet-based audio and video data, and continuous or alert-based human proctoring and intervention via the Internet.

The embodiments described herein utilize statistical analysis of test-response data to automatically and electronically monitor computerized test events, such as, for example, computerized tests administered via computer networks (e.g., the Internet) for indications of test-taker misconduct. When indications of test-taker misconduct are detected, a live proctor can be contacted (e.g., using electronic messages) to remotely monitor the test event using real-time audio and video data feeds. Based on the proctor's observations, the proctor can issue commands to alter, interrupt, or terminate a test event.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example of a computer architecture that facilitates securely administering computerized tests over a network.

FIGS. 2A through 2C illustrate an example flow chart of a method for securely administering a computerized test over a network.

FIG. 3 illustrates an example of a computer architecture that facilitates a net work of proctors.

FIG. 4 illustrates an example Web proctoring application screen that can be presented to a proctor at a proctoring workstation.

FIG. 5 illustrates an example of a watermarked test question.

### DETAILED DESCRIPTION OF THE PREFERRED EMBODIMENTS

The principles of the present invention provide for securely administering computerized tests over a network, such as, for example, the Internet. Embodiments facilitate the delivery of computerized tests via the Internet with unique security features which reduce or eliminate the need for constant human observation of examinees and dedicated testing centers. The system makes test creation, publication, registration and delivery tools accessible to users via the Internet. Security features include real-time analysis of examinee test-response data and test event data (e.g., test response latencies) for indications test-taker misconduct, authentication of examinee identity using biometric information, observation of examinee activity using real-time Internet-based audio and video data, and continuous or alert-based human proctoring and intervention via the Internet.

The embodiments described herein utilize statistical analysis of test-response data to automatically and electronically monitor computerized test events, such as, for example, computerized tests administered via computer networks (e.g., the Internet) for indications of test-taker misconduct. When indications of test-taker misconduct are detected, a live proctor can be contacted (e.g., using electronic messages) to remotely monitor the test event using real-time audio and video data feeds. Based on the proctor's observations, the proctor can issue commands to alter, interrupt, or terminate a test event.

Embodiments of the present invention may comprise a special purpose or general-purpose computer including computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, computer-readable media can comprise physical computer-readable storage media, such as, RAM, ROM, EEPROM, CD-ROM or other optical disk storage, magnetic disk storage or other magnetic storage devices, or any other physical medium which can be used to store desired program code means in the form of computer-executable instructions or data structures and which can be accessed by a general purpose or special purpose computer.

In this description and in the following claims, a “network” is defined as one or more data links that enable the transport of electronic data between computer systems and/or modules. When information is transferred or provided over a network or another communications connection (either hardwired, wireless, or a combination of hardwired or wireless) to a computer, the computer properly views the connection as a computer-readable medium. Thus, by way of example, and not limitation, computer-readable media can also comprise a network or data links which can be used to carry or store desired program code means in the form of computer-executable instructions or data structures and which can be accessed by a general purpose or special purpose computer.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

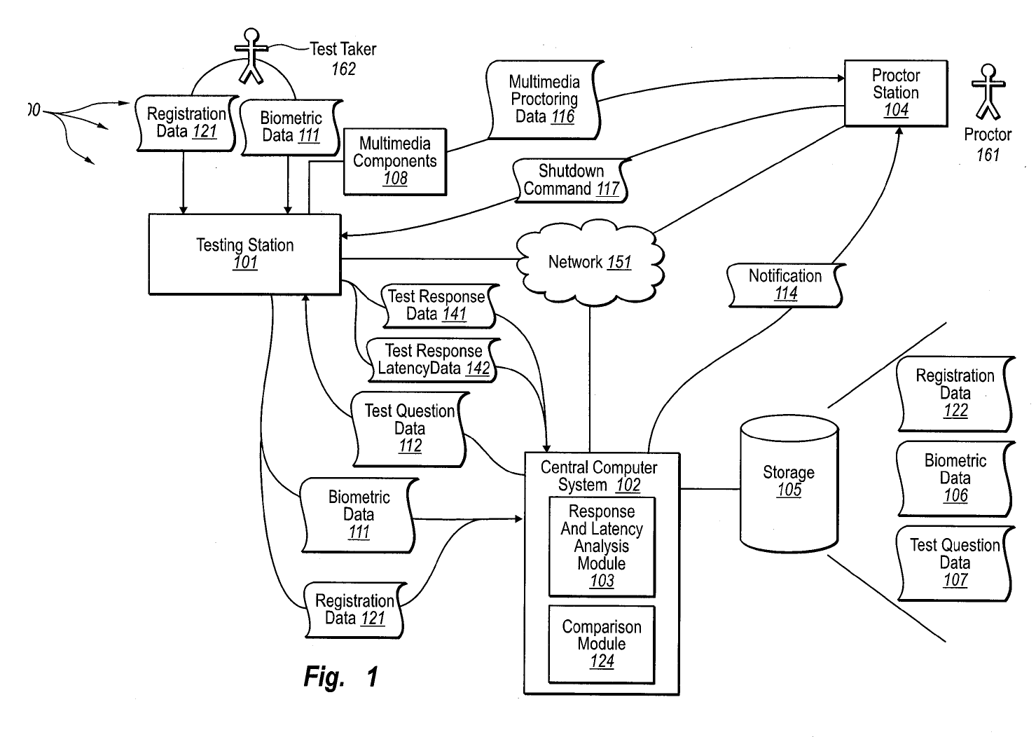

FIGS. 1 illustrates an example of a computer architecture 100 that facilitates securely administering computerized tests over a network, such as, for example, the Internet. Depicted in computer architecture 100 are testing station 101, central computer system 102, and proctor station 104. Generally, testing station 101, central computer system 102, and proctor station 104 can be inter-connected via one or more networks, such as, for example, network 151, which can be a Local Area Network (“LANs”), a Wide Area Network (“WANs”), and even the Internet. Accordingly, testing station 101, central computer system 102, and proctor station 104, as well as other connected computer systems, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the networks.

Testing station 101 is generally configured to administer test events to test-takers in physical proximity to testing station 101. For example, testing station 101 can present test questions and receive test question answers through appropriately configured I/O devices attached to testing station 101. Testing station 101 can also process test question response data and test question response latency for indications of test take misconduct.

Central computer system 102 is generally configured to remotely initiate, administer, and proctor test events. For example, central computer system 102 can send test question data to testing station 101 in response to appropriate data indicating a test event is to occur at testing station 101. Central computer system 102 can also process test question response data and test question response latency for indications of test take misconduct. Storage 105 can store pre-supplied biometric data and registration data (e.g., know to be valid) used to determine if requested test events (e.g., requested from testing station 101) are valid test events.

Proctor station 104 is generally configured to receive data and review the data for test-taker misconduct. For example, proctor station 104 can received test-taker registration data and/or multimedia proctoring data related to a test event and determine if the test event is associated with an increased likelihood of test-taker misconduct. Proctor station 104 can be an integral part of central computer system 101, can be a different computer system in the same physical location as central computer system 101, or can be in a different physical location from central computer system 101.

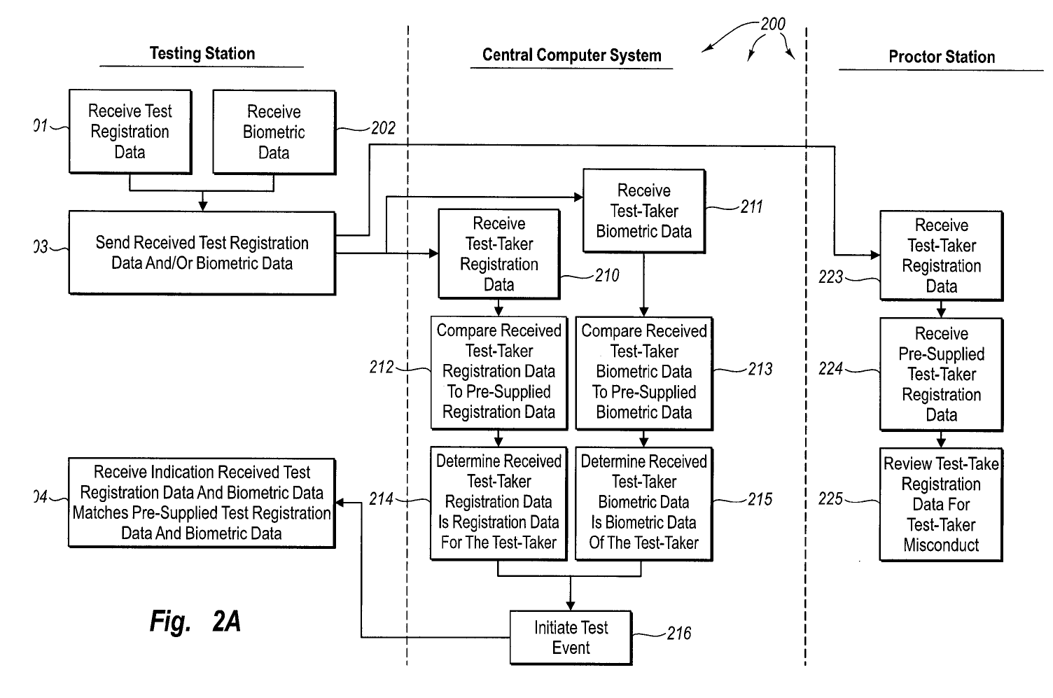

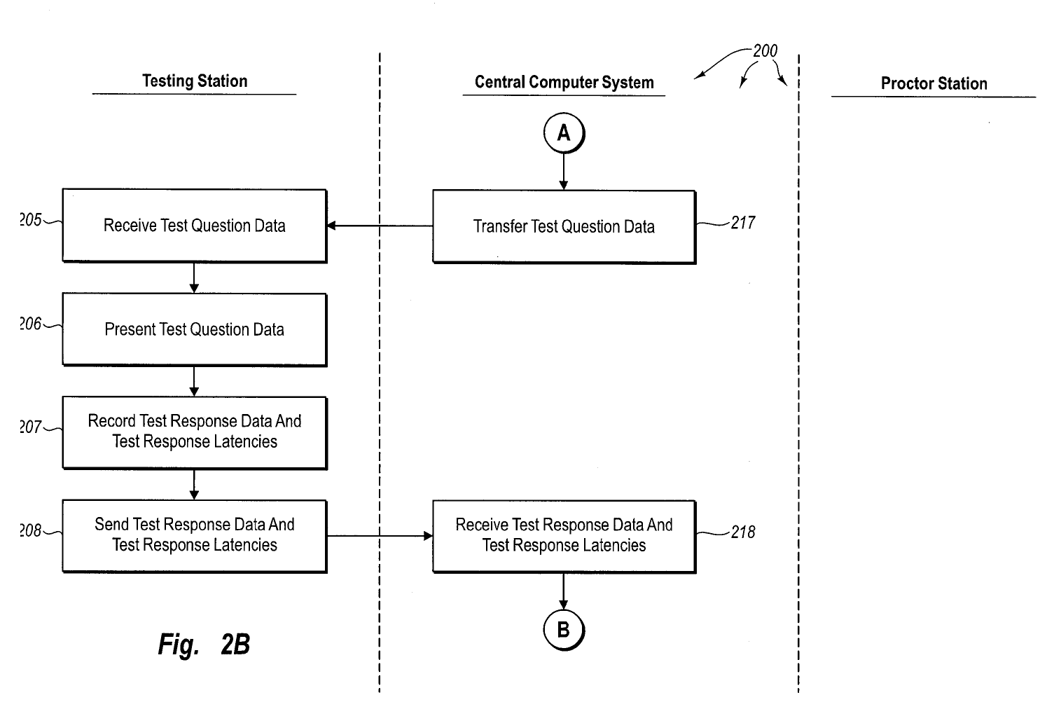

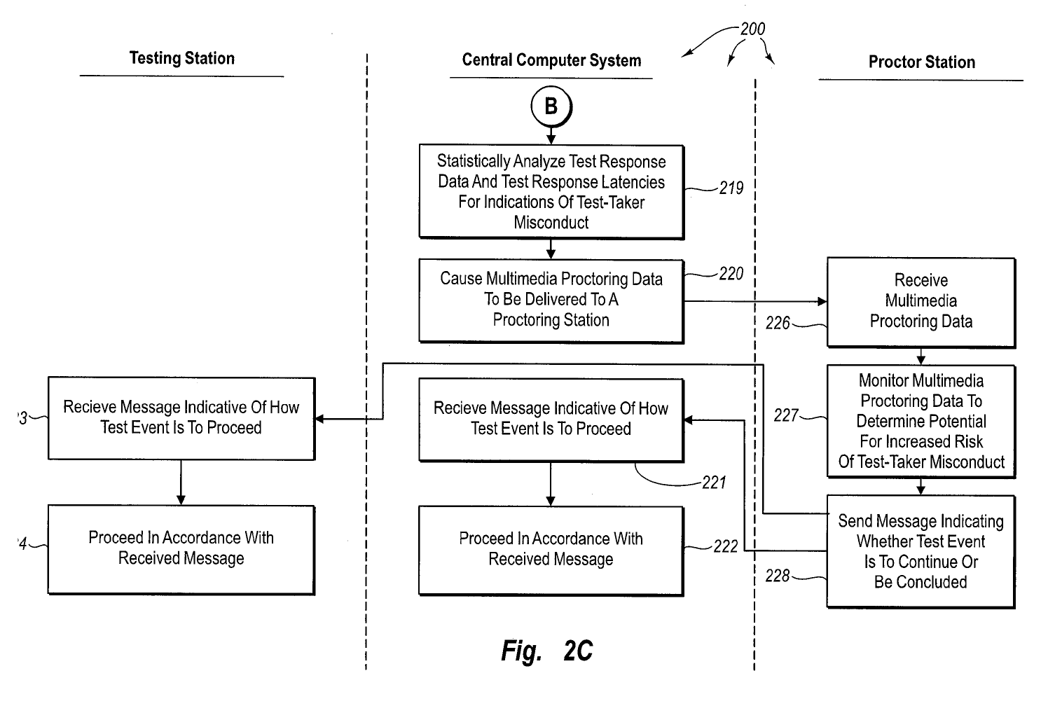

FIGS. 2A through 2? illustrate an example flow chart of a method 200 for securely administering a computerized test. Method 200 will be described with respect to the components and data of computer architecture 100.

Method 200 includes an act of receiving test registration data (act 201). For example, testing station 101 can receive registration data 121. Registration data 121 can be entered by a person in the proximity of testing station 101. Registration data 121 can be purported to be registration data for test-taker 262 and for a specified test event that is to be administered to test-taker 162 at testing station 101. Registration data can include one or more of the test-taker's assigned user name, assigned password, a photograph of the test-taker, and an audio sample of the test-taker.

Method 200 includes an act of receiving biometric data (act 202). For example, testing station 101 can receive biometric data 111. Biometric data 121 can be entered by a person in the proximity of testing station 101. Biometric data can be purported to be biometric data for test-taker 162. Testing station 111 can include or be coupled to an input device for receiving registration data and receiving and/or measuring biometric data, such as, for example, recording a finger print, recording hand geometry, analyzing voice communication, etc. Testing station 101 can be configured to receive registration data and one or more types of biometric data before and/or during and/or after a test event.

Method 200 includes an act of sending received test registration and/or biometric data (act 203). For example, testing station 101 can send registration data 121 and biometric data 111 to central computer system 102. In some embodiments, act 203 also includes testing station 101 sending registration data 121 to proctor station 104. When proctor station 104 is integrally located within central computer system 102, testing station 101 can send registration data 121 to central computer system 102. Central computer system 121 can then handle forwarding registration data 121 to proctor station 104.

Method 200 includes acts of receiving test-taker registration data (acts 210 and 223). For example, central computer system 102 and/or proctor station 104 can receive registration data 121 from testing station 101.

Method 200 an act of receiving test-taker biometric data (act 211). For example, central computer system 102 can receive biometric data 111 from testing station 101.

Method 200 includes an act of comparing received registration data to pre-supplied registration data (act 212). For example, central computer system 102 can store pre-supplied (and possibly known to be valid) test registration data at storage 105 for a plurality of test events that are to be administrated at a plurality of corresponding testing stations. Comparison module 124 can compare received test-taker registration data to pre-supplied registration data for a specified test event. For example, comparison module 124 can compare registration data 121 (purported to be for test taker 162) to registration data 122 (e.g., know to be valid registration for test taker 162) for a test event at testing station 101.

Method 200 includes an act of comparing received registration data to pre-supplied registration data (act 213). For example, central computer system 102 can store pre-supplied (and possibly known to be valid) biometric data at storage 105 for a plurality of test takers that are to participate in test events at a corresponding plurality of corresponding testing stations. Comparison module 124 can compare received biometric data to pre-supplied biometric data. For example, comparison module 124 can compare biometric data 111 (purported to be for test taker 162) to biometric data 106 (e.g., know to be valid biometric for test taker 162).

Method 200 includes an act of determining that received test-taker registration data is registration for the test-taker (act 214). For example, comparison module 124 can determine that registration data 121 sufficiently matches registration data 122 (e.g., within a specified error threshold). Accordingly, comparison module 124 can determine that test-taker 162's registration data was received at testing station 101.

Method 200 includes an act of determining that received test-taker biometric data is biometric data of the test-taker (act 215). For example, comparison module 124 can determine that biometric data 111 sufficiently matches biometric data 106 (e.g., within a specified error threshold). Accordingly, comparison module 124 can determine that test-taker 162's biometric data was received and/or measured at testing station 101.

Method 200 includes an act of receiving pre-supplied test taker registration data (act 224). For example, proctor station 104 can receive (at least a portion of) registration data 122 from central computer system 102. Method 200 includes an act of reviewing test-taker registration data for test-taker misconduct (act 225). For example when appropriate a human proctor at proctor station 104 can review and compare registration data 121 to registration data 122 for test-taker misconduct.

Method 200 includes an act of initiating a test event (act 216). For example, central computer system 102 can initiate a test event at testing station 101 in response to (or based on) registration data 121 being registration data for test taker 162 and biometric data 111 being biometric data for test taker 162. Initiating a test event can include configuring (e.g., securing) testing station 101 to receive test question data for the test event test taker 162 is to take.

Initiating a test event can also include sending an indication to test station 101 that received registration data and/or biometric data match (e.g., within a specified threshold) pre-supplied registration data and biometric data. For example, central station 102 can send an indication that registration data 121 sufficiently matches registration data 122 (e.g., within a specified error threshold) and/or that biometric data 111 sufficiently matches biometric data 106 (e.g., within a specified error threshold) to testing station 101.

Method 200 includes an act of receiving an indication that received registration data and biometric data match pre-supplied registration data and biometric data (act 204). For example, testing station 101 can receive an indication that registration data 121 sufficiently matches registration data 122 (e.g., within a specified error threshold) and/or that biometric data 111 sufficiently matches biometric data 106 (e.g., within a specified error threshold) form central computer system 102.

Method 200 includes an act of transferring test question data (act 217). For example, central computer system 102 can send test question data 112 to testing station 101. Test question data 112 can be subset of test question data 107 stored at storage 105. Test question data 107 can be used to initiate test events (e.g., instances of standardized tests) at testing stations. Portions of test question data 112 can have a structured order indicating when portions of test question data 112 are to be presented. Thus, it may be that testing station 101 can use test question data 112 to initiate an instance of a computerized test at testing station 101

Method 200 includes an act of receiving test question data (act 205). For example, testing station 101 can receive test question data 112 from central computer system 102.

Method 200 includes an act of presenting test question data (act 206). For example, testing station 101 can present test question data 112 for a test event. When test question data 112 as a structured order, testing station 101 can present test question data in accordance with the structured order. A test event can include presenting test questions and possible test answers on a user-interface at testing station 101. The test-taker can select possible answers using an input device (e.g., keyboard or mouse) coupled to testing station 101.

Testing station 101 can include memory, for example, system memory, that stores selected possible answers. Testing station 101 can also store other test event related data, such as, for example, test response latencies. A test response latency can be the elapsed time between receiving consecutive answer selections. For example, if one answer selection is received at 10:01:07 and a next answer selection is received at 10:02:09, the test response latency between the two answer selections would be 62 seconds. Testing station 101 can be configured to store individual tests response latencies, store an average for some subset of test questions, store an average for all test questions, etc.

Method 200 includes an act of recording test response data and test response latencies (act 207). Testing station 101 can record test response data and test response latencies for test taker 162 for a test event delivered at computer station 101. For example, testing station 101 can store test response data 141 and test response latency data 142. Test response data 141 can include answer selections for one, some, or all of the questions associated with a test event at testing station 101. Test response latency data 142 can include test response latencies (time) between some or all of the consecutive answer selections of the test event at testing station 101.

Method 200 includes an act of sending test response data and test response latency data (act 208). For example, testing station 101 can send test response data 141 and test response latency data 142 to central computer system 102. Method 200 includes an act of receiving test response data and test response latency data (act 218). For example, central computer system 102 can receive test response data 141 and test response latency data 142 form testing station 101.

Method 200 includes an act of statistically analyzing test response data and test response latency data (act 219). For example, response and latency analysis module 103 can analyze test response data 141 and test response latency data 142 for indications of test-taker misconduct occurring during the test event at testing station 101. Analysis of test response data 141 and test response latency data 142 can be used to detect, for example, an increased risk of question memorization (test theft) based on a comparison of test response latencies to expected values based on pre-assigned question difficulties.

Test response data and test response latency data can be sent and received during the test event as test response selections are received.

Based on analysis of test response data 141 and test response latency data 142, response and latency analysis module 103 may determine that the test event has an increased risk of test-taker misconduct. Thus, in some embodiments, central computer system 102 functions as system configured to detect test-taker misconduct, using statistical analyses of test results. Test-centric, normative (statistical) models of test-taking behavior can be used to detect test event irregularities which signal an elevated risk of test-taker misconduct. The statistical models are used to analyze test question responses, test question latencies, test scores and other test event information, and can be calibrated to increase or decrease the likelihood of different types of error. During or following the test administration process, the models can be implemented to estimate the probability of test-taker misconduct.

Base statistical models can be generated for different types of test-taker misconduct including collusion, test theft, testing policy violations, unusual score gains and drops between successive administrations of a test, and answer-changing. Base statistical models can generate probability estimates using the output of standard statistical models including nominal item response and regression models, and may be calibrated for individual tests. Simulations and the estimation of parameters for statistical distributions can be used for establishing appropriate probability thresholds. Embodiments of the invention can combine multiple statistical models and analyses to detect test-taker misconduct.

Indicators of test-taker misconduct that result from application of the base statistical models can indicate a level of confidence regarding the presence in the test event of test-taker misconduct.

A first indicator, test response aberrance index, can be used to estimate the probability of test-taker misconduct due to test event and response patterns that do not conform to estimations of reasonably expected response behavior predicated by a nominal item response model.

A second indicator, a collusion or answer-copying index, can be used to estimate the probability of test-taker misconduct based on the similarity between two or more sets of test event and response data from two or more test-takers. An appropriate statistical model provides probability estimates regarding the degree of similarity between test event and response data derived from individual administrations of a test.

A third indicator, a “gain-score” index, can be used to estimate the probability of test-taker misconduct based on unusual score gains and score drops between successive administrations of a test for a single test-taker or a group of test-takers.

A fourth indicator, erasure or answer-changing index, can be used to estimate the probability of test-taker misconduct based on modification of answers made during or after of the administration of a test. Erasure measures may indicate the presence of test-taker misconduct in one or more administrations of a test.

It would be apparent to one skilled in the art, that a variety of additional indicators and/or analyses can be used for the detection of test-taker misconduct including: analysis of individual testing policy violations (e.g., test re-take violations), analysis of biometric response data including keystrokes, test administration time-of-day analysis, etc.

Aggregation of indicators can strengthen inferences about the presence of test-taker misconduct and can enhance the individual detection capability of the different measures, such as, for example, the involvement of test site administrators or proctors in the prohibited conduct.

Time-series analysis of test-taker misconduct indicators along with test scores and pass-rates can be used to provide meaningful evidence of the degradation of the measurement performance of a test attributable to test-taker misconduct over the life of the test. Thus, time series analysis can indicate that a test is no longer performing as designed or desired.

Method 200 includes an act of causing multimedia proctoring data to be delivered to a proctoring station (act 220). For example, central computer system 102 can cause multimedia proctoring data 116 to be delivered to proctor station 104 (when appropriate in essentially real-time) in response to an indication of test-taker misconduct. Multimedia components 108 can include a video recording device, audio recording device, physical security components (door locks, testing station tamper switches, etc.), etc. for monitoring physical activities in vicinity of testing station 101. In response to an indication of an increased risk of test-taker misconduct, central computer system 102 can activate multimedia components 108 to begin monitoring the vicinity of testing station 101 and deliver multimedia proctoring data (video, audio, switch activations, etc) to proctoring station 104. Alternately, when multimedia components are already monitoring and/or recording the vicinity of testing station 101, central computer system 102 can redirect the output of multimedia components 108 to proctor station 104.

Method 200 includes an act of receiving multimedia proctoring data (act 226). For example, proctor station 104 can receive multimedia proctoring data 116 from central computer system 102 (when appropriate in essentially real-time).

Central computer system 102 can send notification 114 to proctor station 104 to notify proctor station 104 that it is going to send multimedia data 116.

Method 200 includes an act of monitoring multimedia proctoring data (e.g., audio/video data) to determine potential for increased risk of test taker misconduct (act 227). For example, a human proctor can observe a test-taker during the completion of a plurality of test questions either continuously or as prompted by the central computer system (e.g., included in notification 114). Method 200 includes an act of sending a message indicating whether the test event is to continue or be concluded (act 228). For example, based on the results of observing the test-taker, the human proctor can decide what is to be done with test response data 141. For example, the human proctor can decide to alter, interrupt, or conclude a test event. Generally, proctor station 104 can send a message indicating whether a test event at testing station 101 is to continue or be concluded, thereby relaying the proctor's decision to testing station 101 and/or central station 102. For example, proctor station 104 can send shut down command 117 to testing station 101 to stop a test event before the test event is complete.

Method 200 includes an act of receiving a message that indicates how the test event is to proceed (act 223 and/or act 221). Generally, testing station 101 can receive a message from proctor station 104 indicating whether the test event is to continue or be concluded. For example, testing station 101 can receive shutdown command 117 from proctor station 104. Alternately, central computer system 102 can receive a shutdown command or some other message from proctor station 104, for example, indicating that test response data 141 is to be invalidated and a test event at testing station 101 is to be altered, interrupted, or concluded.

Method 200 includes an act of proceeding in accordance with the received message (act 224 and/or act 222). For example, in response to receiving shutdown command 117, testing station 101 can determine that a test event is to be shutdown. Central computer system 102 can instruct testing station 101 to implement appropriate operations (e.g., alter, interrupt, or shut down a test event) in response to message from proctoring station 104.

Thus, review of multimedia proctoring data at a proctor station can be continuous or initiated in response to analysis of test response data and test response latency data (either solely or in combination with other proctoring data). Accordingly, a proctor is alerted when statistical indicators indicate an elevated risk of test-taker misconduct. Notification of potential test-taker misconduct relieves a proctor from having to continuously monitor a test-taker and thus conserves manpower and computer system resources and allows a single proctor to monitor several test events simultaneously). The application of statistical analyses also assists a proctor in detecting forms of test-taker misconduct that do not include physical actions (e.g., question memorization).

When statistical indicators indicate that a test event exhibits an elevated risk of test-taker misconduct software at central computer system 102 can be perform one or more of: alerting a web proctor, altering, interrupting, or stopping the test, substituting a test questions, and flagging a test event for further review without providing a score.

Further, as previously described, when alerted by statistical indicators, a human proctor located at a remote proctoring station (e.g., connected to the Internet) can accesses real-time multimedia information (e.g., an audio/video) stream to confirm suspicion of test-taker misconduct. The proctor can watch and listen to the test-taker and decide whether to alter, interrupt, or stop the test event. If a decision is made to stop the test, the proctor can answer a short Internet-based survey related to what he/she heard and saw tending to confirm the suspicion of test-taker misconduct.

Embodiments of the present invention can use a network of remote proctors (e.g., with connectivity to the Internet) to quickly handle a high number of alerts.

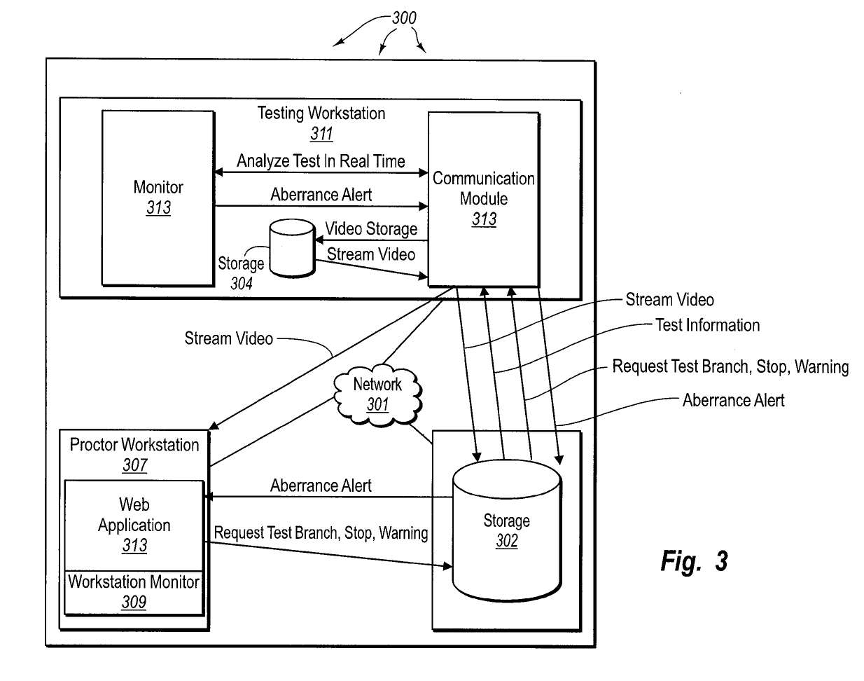

FIG. 3 illustrates an example of a computer architecture 300 that facilitates a network of proctors. As depicted, computer architecture 300 includes network 301 (e.g., the Internet), testing workstation 311 (e.g., similar to testing station 101), proctor workstation 307 (e.g., similar to protocol station 104), and storage 302 (e.g., similar to storage 105). Relative to network 301, testing workstation 311, proctor workstation 307, and storage 302 can be remotely located from one another (e.g., separated by one or more routers). It should be understood that other remotely located testing workstations and proctoring workstations can also be connected to network 301.

Testing workstation 311 includes monitor 303, communication module 306, and storage 304. Monitor 303 is configured to monitor activities related to test events administered at testing workstation 311. Communication module 306 is configured to facilitate communication with other modules and computer systems via network 301. Storage 304 is configured to buffer video data for video to facilitate video streaming to storage 302 and/or proctor workstation 307.

Proctor workstation 307 includes Web application 308 and workstation monitor 309. Web application 308 is configured to provide an interface for responding to statistical alerts. Workstation monitor 309 monitors the available resources of proctor workstation 307 (e.g., system memory, speed, available bandwidth) to determine if proctor workstation 307 meets processing requirements responding to statistical alerts.

In some embodiments, before any test can be proctored, various proctoring parameters are negotiated between a proctor station and a testing station. For example, a proctoring type, such as, for example, full time or by alert. Alert levels can be set to make the system more or less sensitive, including sensitivity levels for sound, video, and statistical indicators.

If an alert occurs and a Proctor needs to take action, they choose for a preset list of approved outcomes including: interrupting the test event to warn the test-taker about excessive noise or talking; interrupting the test event to warn the test-taker about his/her movement (e.g., hands left the keyboard); delivery of alternative test questions; or stopping the test.

Once the proctor has indicated his/her decision to the central computer, the central computer sends an appropriate, pre-defined message to the examinee.

Proctor observations of multimedia test data can be supplemented or supplanted by automated analysis of that data at the central computer or the proctor station for indications of test-taker misconduct, such as excessive noise or movement. If the results of automated analyses of multimedia test data exceed pre-defined thresholds for noise or movement, an alert is sent to the proctoring station and the automated analysis is supplemented or supplanted by live proctoring.

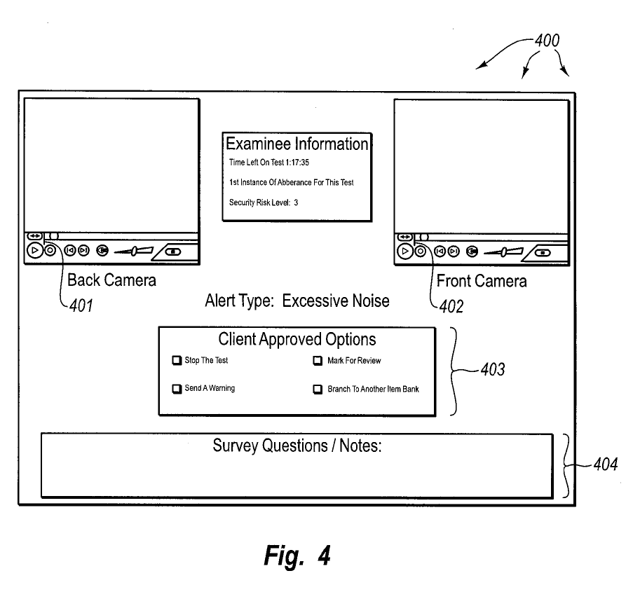

FIG. 4 illustrates an example of Web proctoring application screen 400 that can be presented to a proctor at a proctoring workstation. When viewing Web proctoring application screen 400, a proctor can see the examinee (front and back cameras) and observe whether there is excess noise or movement in the testing area. The proctor can also see towards the rear of the testing monitor, thus they are able to detect if someone or something is out of the visual range of the other camera

Vertical lines 401 and 402, depicted on the forward and back camera application, indicate the point (in time) when the statistical indicators alerted an elevated risk of test-taker misconduct. The proctor may move the slide bar to review multimedia test data collected before, during, or after the time the alert was generated. The Proctor is presented with possible actions 403 for outcomes that can be taken based upon his/her review of the multimedia test data. The proctor then records an account of his/her observations by completing survey 404, thus documenting the incident.

Watermarking relates to a set of procedures for modifying test question screens and other test question attributes in order to reliably identify the origin of test questions or test components that are misappropriated by test-takers or others, and transferred to other contexts (e.g., a Website). Digital and text watermarks can be used independently or in combination to discourage the recording of test question data with cameras or other devices, and the reconstruction of test question data from the test-taker's memory following the test event.

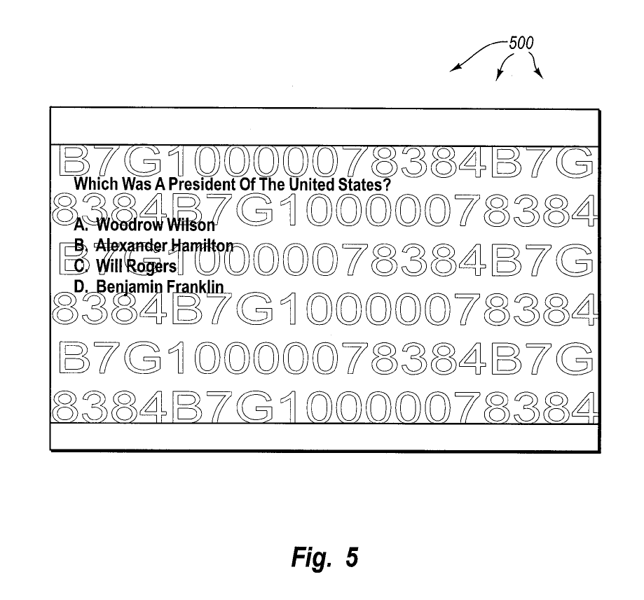

In some embodiments, the central computer or the testing station can generate in the background of a test question presented at the testing station, a unique identifier which encodes information identifying the test-taker and the test event. FIG. 5 illustrates an example of a watermarked test question 500.

In other embodiments, software running on the central computer or the testing station can substitute text elements contained in test question data that are immaterial to the validity of the test question including, in some instances, names, dates and punctuation. The selection of text substitutions is determined by an algorithm in the software which can be reversed and used in other contexts to decode the text substitutions and identify the test-taker and test event. An additional benefit of text watermarking is to make test questions more immune to sharing between test takers who may not recognize the shared questions on a later test.

An example of text watermarking is provided below. The text underlined in the example question (taken with permission from a retired Hewlett-Packard certification test), can be modified without altering the purpose or validity of the test question.
An HP ProLiant server is running Microsoft Windows 2003 Enterprise Edition and has three Intel Xeon processor MPs at 2.8 GHz. Hyper-Threading is enabled in the BIOS and in the operating system. How many logical processors can the operating system use?
A. three
B. four
C. six
D. eight
E. thirty-two

Potions of equivalent text for each underlined passages in the above example are described below (however other and additional equivalent portions of text are also possible).

| Original Text | Possible Substitute Text |
|---|---|
| An HP | A Hewlett-Packard |
| | A |
| | A large |
| | A specific |
| is running | runs |
| | is using |
| | uses |
| | has running on it |
| MPs | MP's |
| is enabled | is allowed |
| | is active |
| | operates |
| the BIOS and in the | in the operating system and in the BIOS |
| operating system | in the OS and in the BIOS |
| | in the OS and BIOS |
| can the operating system | can be used by the operating system |
| use | can be used by the OS |
| | can the OS use |
| | can the system use |
| | can be used by the system |

There are approximately 4800 possible combinations of the possible text substitutes described above. The number of supported combinations can be scaled to the expected number of test events that include the test question.

FIG. 5 illustrates an example of a watermarked test question 500.

In accordance with the present invention, modules including testing station modules, multimedia components, central computer system components, response and latency analysis modules, test registration and biometric data comparison module, and proctor station components as well as associated data, including test registration and biometric data, test question data, test responses, test latencies, notifications, multimedia proctoring data, and shut down commands, can be stored and accessed from any of the computer-readable media associated with a computer system. When a mass storage device, such as, for example, storage 105, is coupled to a computer system, such modules and associated program data may also be stored in the mass storage device. In a networked environment, program modules relative to a computer system, or portions thereof, can be stored in remote memory storage devices, such as, system memory and/or mass storage devices associated with remote computer systems. Execution of such modules may be performed in a distributed environment as previously described.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a central computer system configured to remotely initiate, administer, and proctor test events, a method for administering a remotely proctored test, the method comprising:
an act of initiating a test event for a test-taker at a remote computer system based on a determination that that remotely entered registration data is the registration data of the test-taker and a determination that remotely entered biometric data is the biometric data of the test-taker;
an act of transferring test question data that can be used to administer an instance of a test, the test question data transferred in accordance with a structured order;
an act of receiving test response data and test response latencies corresponding to the test event, the test response data representing answers to questions of a test instance that was generated from the test question data, the test response latencies representing at least the amount of time between reception of answers for questions of the test instance; and
an act of statistically analyzing the test response data and test response latencies for indications of test-taker misconduct occurring during the test event.

2. The method as recited in claim 1, further comprising:
prior to initiating the test event at the remote computer system:
an act of receiving test-taker registration data remotely entered by a test-taker from a remote computer system or workstation, the entered registration data purported to be registration data belonging to the test-taker;
an act of receiving biometric data remotely entered by a test-taker from a remote computer system or workstation, the entered biometric data purported to be biometric data belonging to the test-taker;
an act of comparing the registration data entered by the test-taker to pre-supplied registration data stored on the central computer system;
an act of comparing the biometric data entered by the test-taker to biometric data stored on the central computer system;
an act of determining that the remotely entered registration data is the registration data of the test-taker based on the comparison; and
an act of determining that the remotely entered biometric data is the biometric data of the test-taker based on the comparison.

3. The method as recited in claim 2, wherein receiving registration data comprises receiving registration data including at least the test-taker's assigned user name, assigned password, a photograph of the test-taker, and an audio sample of the test-taker.

4. The method as recited in claim 1, further comprising:
an act of determining that the test event has an increased risk of test-taker misconduct based on the statistical analysis of the test response data and test response latencies.

5. The method as recited in claim 4, wherein the act of determining that the test event has an increased risk of test-taker misconduct comprises an act of comparing results of the statistical analysis of the test response data and test response latencies to expected values.

6. The method as recited in claim 4, wherein the act of determining that the test event has an increased risk of test-taker misconduct comprises an act of determining, during the test event, that the test event has an increased risk of test-taker misconduct.

7. The method as recited in claim 6, further comprising:
an act of causing multimedia proctoring data for the test event to be delivered to a remote proctoring station in essentially real-time at least in response to the determination, based on the analysis of the test response data and test response latencies, that the test event has an increased risk of test-taker misconduct, the multimedia proctoring data indicating the actions of the test-taker as test response data is entered at the remote computer system during the test event; and
act of receiving a message from the remote proctoring station indicating how the test event is to proceed based on the information contained in the multimedia proctoring information, the message indicative of a human test proctor having reviewed the multimedia proctoring data to confirm whether the test event is valid, based on the analysis of the test response data and test response latencies, due to an increased risk of test-taker misconduct.

8. The method as recited in claim 7, wherein the act of causing multimedia proctoring data for the test event to be delivered to a remote proctoring station in essentially real-time comprises an act of forwarding multimedia proctoring data received from audio/video devices monitoring the test event to the remote proctoring station.

9. The method as recited in claim 7, wherein the act of causing multimedia proctoring data for the test event to be delivered to a remote proctoring station in essentially real-time comprises an act of causing multimedia proctoring data for the test event to be delivered to a remote proctoring station that is in network communication with the central station.

10. The method as recited in claim 7, wherein the act of receiving a message from the remote proctoring station indicating how the test event is to proceed based on the information contained in the multimedia proctoring information comprises an act of receiving a message that indicates an action is to be applied to the test event, the action selected from among altering the test event, interrupting the test event, and invalidating and concluding the test event.

11. The method as recited in claim 7, further comprising:
an act of issuing a stop command to the remote computer system, the issued stop command for stopping the test event.

12. The method as recited in claim 7, further comprising:
an act of issuing an interrupt command to the remote computer system, the issued interrupt command for interrupting the test event to warn the test-taker of suspected misconduct.

13. The method as recited in claim 7, further comprising:
an act of altering the number, type, and order of tests questions sent to a remote testing station for a test event.

14. The method as recited in claim 4, wherein the act of determining that the test event has an increased risk of test-taker misconduct comprises an act of determining, after the test event, that the test event has an increased risk of test-taker misconduct based on the analysis of the test response data and test response latencies.

15. The method as recited in claim 14, further comprising:
an act of causing multimedia proctoring data for the test event to be delivered to a remote proctoring station at least in response to the determination, based on the analysis of the test response data and test response latencies, that the test event has an increased risk of test-taker misconduct, the multimedia proctoring data indicating the actions of the test-taker as test response data is entered at the remote computer system during the test event; and
an act of receiving a message from the remote proctoring station indicating what is to be done with the results of the test event based on the information contained in the multimedia proctoring information, the message indicative of a human test proctor having reviewed the multimedia proctoring data to confirm whether the test event was valid, based on the analysis of the test response data and test response latencies, due to an increased risk of test-taker misconduct.

16. The method as recited in claim 15, wherein the act of causing multimedia proctoring data for the test event to be delivered to a remote proctoring station comprises an act of forwarding multimedia data received from audio/video devices monitoring the test event to the remote proctoring station.

17. The method as recited in claim 15, wherein the act of causing multimedia proctoring data for the test event to be delivered to a remote proctoring station comprises an act of causing multimedia proctoring data for the test event to be delivered to a remote proctoring station that is in network communication with the central station.

18. The method as recited in claim 11, wherein the act of receiving a message indicating what is to be done with the results of the test event comprises an act of receiving a message that indicates the test event is to be invalidated.

19. The method as recited in claim 1, further comprising:
an act of determining that the test event is valid based on one or more of the statistical analysis and proctor feedback; and
an act of calculating a test score for the test-taker.

20. The method as recited in claim 19, further comprising:
an act of generating a non-alterable, non-reproducible photo image of the test-taker; and
an act of displaying the test-taker's test score on the non-alterable, non-reproducible photo image of the test-taker.

21. The method as recited in claim 1, further comprising:
an act of generating a unique identifier for a test event identifying one more of the test-taker, the testing center presenting the test, the remote testing station presenting the test, the date of the test event, and the time of the test event.

22. The method as recited in claim 21, further comprising:
an act of inserting the unique test event identifier in the display of all or a portion of the test questions in a test event, the unique test event identifier identifying one more of the test-taker, the testing center presenting the test, the remote testing station presenting the test, the date of the test event, and the time of the test event to associate with test questions.

23. The method as recited in claim 21, further comprising:
an act of storing the unique identifier along with each test question.

24. The method as recited in claim 21, further comprising:
an act of associating the unique test event identifier with an algorithm identifier identifying an algorithm which specifies the substitution of text in a test question that is immaterial to the validity of the test question;
an act of substituting irrelevant text in a test question using the algorithm; and
an act of storing the unique test event identifier along with the algorithm identifier of the algorithm.

25. At a central computer system configured to remotely initiate, administer, and proctor test events, a method for securely initiating a test event, the method comprising:
an act of receiving test-taker registration data, the test-taker registration data remotely entered at a remote testing station, the entered registration data purported to be registration data belonging to the test-taker and for a specified test event to be administered to the test-taker;
an act of receiving test-taker biometric data, the test-taker biometric data remotely entered at the remote testing station, the entered biometric data purported to be biometric data belonging to the test-taker;
an act of comparing the received test-taker registration data entered by the test-taker to pre-supplied registration data for the test event stored on the central computer system;
an act of comparing the received test-taker biometric data entered by the test-taker to pre-supplied biometric data stored on the central computer system;
an act of determining that the received test-taker registration data is the registration data of the test-taker and is for administration of the specified test event based on the comparison;
an act of determining that the received test-take biometric data is the biometric data of the test-taker based on the comparison; and
an act of initiating the specified test event for the test-taker in response to a determination that the remotely entered registration data is the registration data of the test-taker for the specified test event and a determination that remotely entered biometric data is the biometric data of the test-taker.

26. The method as recited in claim 25, wherein receiving registration data comprises receiving registration data including one or more of the test-taker's assigned user name, assigned password, a photograph of the test-taker, and an audio sample of the test-taker.

27. The method as recited in claim 25, wherein receiving biometric data comprises receiving one or more of a finger print, hand geometry, and sample of voice communication of the test-taker.

28. At a testing station configured to administer test events, a method for securely administering a test, the method comprising:
an act of receiving test registration data entered at the testing station by a test-taker;
an act of a receiving biometric data entered at the testing station by a test-taker;
an act of sending the received test registration and biometric data to a central computer system that supplies test question data for test events, the central computer system storing pre-supplied test registration data and biometric data for potential test-takers;
an act of receiving an indication that the entered test registration and biometric data matches pre-supplied test registration and biometric data for the test-taker;
an act of receiving test question data from the central computer system, the test question data for initiating a test event at the testing station;
an act of presenting a portion of received test question data; and
an act of recording test response data and test response latencies for the test event, the test response data representing answers to an instance of the test that was generated from the test question data, the test response latencies representing at least the amount of time between reception of answers for questions of the test instance.

29. The method as recited in claim 28 further comprising:
an act of appropriately restricting test-taker access to the remote testing station.

30. The method as recited in claim 28, further comprising:
an act of statistically analyzing the test response data and test response latencies for indications of test taker misconduct occurring during the test event.

31. The method as recited in claim 30, further comprising:
an act of determining that the test event has an increased risk of test-taker misconduct based on the analysis of the test response data and test response latencies.

32. The method as recited in claim 19, further comprising:
an act of sending the test response data and test response latencies to the central computer system; and
an act of receiving a message from the central computer system, the message indicating that the test event has an increased risk of test-taker misconduct, the message generated at the central computer system in response to statistical analysis of the test response data and test response latencies received from the testing station.

33. The method as recited in claim 32, wherein the act of receiving a message from the central computer system comprises an act of receiving a stop command indicating that the test event is to be stopped.

34. The method as recited in claim 23, further comprising:
an act of interrupting the test event in response to receiving the interrupt command; and
an act of stopping the test event in response to receiving the stop command.

35. The method as recited in claim 34, further comprising:
an act of presenting a message to the test-taker in response to receiving the interrupt command.

36. The method as recited in claim 34, further comprising:
an act of presenting a message to the test-taker in response to receiving the stop command.

37. The method as recited in claim 28, further comprising:
an act of rendering multimedia proctoring data continuously or in response to an indication that the test event has an increased risk of test-taker misconduct based on the analysis of test-response and test latency data; and
an act of sending multimedia proctoring data to the remote proctoring station continuously or in response to an indication that the test event has an increased risk of test-taker misconduct based on the analysis of test-response and test latency data.

38. The method as recited in claim 37, wherein the act of sending multimedia proctoring data to a remote proctoring station continuously or in response to an indication that the test event has an increased risk test-taker misconduct comprises an act of sending multimedia proctoring data to a remote proctoring station essentially in real-time such that a human proctor can monitor the multimedia proctoring data during the test event.

39. The method as recited in claim 37, wherein the act of sending multimedia proctoring data to a remote proctoring station continuously or in response to an indication that the test event has an increased risk of test-taker misconduct comprises an act sending multimedia proctoring data to a remote proctoring station after the test event such that a human proctor can review the multimedia proctoring data.

40. The method as recited in claim 28, wherein the act of receiving biometric data comprises an act of receiving biometric data at a biometric measuring device coupled to the testing station.

41. The method as recited in claim 40, wherein the act of receiving biometric data at a biometric measuring device coupled to the testing station comprises an act of receiving biometric data at a biometric measuring device selected from among devices for recording a finger print image, a device for recording a retinal image, a device for recording a hand geometry image, and a device for analyzing voice communication.

42. The method as recited in claim 28, wherein the act of receiving test registration and biometric data at the testing station comprises an act of receiving test registration and biometric data at the testing station prior to initiating the test event.

43. The method as recited in claim 28, wherein the act of receiving test registration and biometric data at the testing station comprises an act of receiving test registration and biometric data at the testing station after completion of the test event.

44. The method as recited in claim 28, wherein the act of receiving test registration and biometric data at the testing station comprises an act of receiving test registration and biometric data at the testing station during the test event.

45. The method as recited in claim 28, wherein the act of sending the received test registration and biometric data to a central computer system comprises an act of sending the received test registration and biometric data to a central computer system prior to initiating the test event.

46. The method as recited in claim 28, wherein the act of sending the received test registration and biometric data to a central computer system comprises an act of sending the received test registration and biometric data to a central computer system after competition of the test event.

47. The method as recited in claim 28, wherein the act of sending the received test registration and biometric data to a central computer system comprises an act of sending the received test registration and biometric data to a central computer system during the test event.

48. The method as recited in claim 28, wherein the act of receiving test question data from the central computer system comprises an act of receiving test question data from the central computer system in response to a determination that the entered test registration and biometric data matches pre-supplied test registration and biometric data for the test-taker.

49. At a proctor station configured to receive test registration and multimedia proctoring data associated with computerized test events, a method for reviewing test registration and proctoring data for a computerized test event, the method comprising:
an act of receiving pre-supplied test registration data for a test-taker;
an act of receiving user-entered test registration data entered by the test-taker at the remote testing station;
an act of reviewing at least a portion of the pre-supplied test registration data and at least a corresponding portion of the user-entered registration data to determine whether there is an increased risk of test-taker misconduct for the test event;
an act of receiving multimedia proctoring data, the multimedia proctoring data received at the proctor station continuously or in response to statistical analysis of test response data and test response latencies for the test event indicating that the test event has an increased risk of test-taker misconduct, the test response data representing answers to test questions presented during the test event, the test response latencies representing at least the amount of time between reception of answers to test questions included in the test event;
an act of reviewing at least a portion of the multimedia proctoring data to determine potential for increased risk of test-taker misconduct; and
an act of sending a message that indicates what is to be done with the results of the test event based on the information contained in the multimedia proctoring information, the message indicative of a human test proctor having reviewed the pre-supplied and user-entered registration and the multimedia proctoring data to confirm whether the test event was valid.

50. The method as recited in claim 49, wherein the act of receiving multimedia proctoring data comprises an act of receiving multimedia proctoring data for the test event essentially in real-time during the test event.

51. The method as recited in claim 47, wherein the act of receiving multimedia proctoring data comprises an act of receiving multimedia proctoring data for the test event after the test event is complete.

52. The method as recited in claim 49, wherein the act of reviewing at least a portion of the multimedia proctoring data to determine whether the multimedia proctoring data indicates an increased risk of test-taker misconduct comprises an act of observing a test-taker during the completion of a plurality of test questions continuously or as prompted by the central station.

53. The method as recited in claim 49, wherein the act of sending a message that indicates what is to be done with the results of the test event comprises an act of sending a message that indicates that the test event is to be altered, interrupted, or invalidated and concluded based on review of the test registration and/or multimedia proctoring data.

54. The method as recited in claim 49, wherein the act of sending a message that indicates whether the test event is to be altered, interrupted, or invalidated and concluded comprises an act of sending an alter, interrupt, or stop command to corresponding alter, interrupt, or stop the test event.

55. The method as recited in claim 49, further comprising:
an act of sending a message to the test-taker along with an interrupt command.

56. The method as recited in claim 49, further comprising:
an act of sending a message to the test-taker along with a stop command.

57. A computer program product for use at a central computer system configured to remotely initiate, administer, and proctor test events, the computer program product for implementing a method for administering a remotely proctored test, the computer program product comprising one or more physical computer-readable media having stored thereon computer-executable instructions that, when executed by a processor, cause the central computer system to perform the following:
initiate a test event for a test-taker at a remote computer system based on a determination that that remotely entered registration data is the registration data of the test-taker and a determination that remotely entered biometric data is the biometric data of the test-taker;
transfer test question data that can be used to administer an instance of a test;
structure the order in which the test questions for a test event are delivered;
receive test response data and test response latencies corresponding to the test event, the test response data representing answers to questions of a test instance that was generated from the test question data, the test response latencies representing at least the amount of time between reception of answers for questions of the test instance; and
statistically analyze the test response data and test response latencies for indications of test-taker misconduct occurring during the test event.

58. The computer program product as recited in claim 57, wherein the one or more physical computer-readable media include system memory.

59. A computer program product for use at a central computer system configured to remotely initiate, administer, and proctor test events, the computer program product for implementing a method for securely initiating a test event, the computer program product comprising one or more physical computer-readable media having stored thereon computer-executable instructions that, when executed by a processor, cause the central computer system to perform the following:
receive test-taker registration data, the test-taker registration data remotely entered by a test-taker from a remote computer system, the entered registration data purported to be registration data belonging to the test-taker and for a specified test event to be administered to the test-taker;
receiving biometric data remotely entered by a test-taker from a remote computer system, the entered biometric data purported to be biometric data belonging to the test-taker;
compare the received registration data entered by the test-taker to pre-supplied registration data for the test event stored on the central computer system;
compare the biometric data entered by the test-taker to biometric data stored on the central computer system;
determine that the remotely entered registration data is the registration data of the test-taker and for administration of the specified test event based on the comparison;
determine that the remotely entered biometric data is the biometric data of the test-taker based on the comparison; and
initiate the specified test event for the test-taker in response to determining that the remotely entered registration data is the registration data of the test-taker for the specified test event and a determination that remotely entered biometric data is the biometric data of the test-taker.

60. The computer program product as recited in claim 59, wherein the one or more physical computer-readable media include system memory.

61. A computer program product for use at a testing station configured to administer test events, the computer program product for implementing a method for securely administering a test, the computer program product comprising one or more physical computer-readable media having stored thereon computer-executable instructions that, when executed by a processor, cause the testing station to perform the following:
receive test registration data entered at the testing station by a test-taker;
receive biometric data entered at the testing station by a test-taker;
send the received test registration and biometric data to a central computer system that supplies test question data for test events, the central computer system storing pre-supplied test registration and biometric data for potential test-takers;
receive an indication that the entered test registration and biometric data matches pre-supplied test registration and biometric data for the test-taker;
receive test question data from the central computer system, the test question data for initiating a test event at the testing station;
initiate a test event based on the received test question data; and
record test response data and test response latencies for the test event, the test response data representing answers to an instance of the test that was generated from the test question data, the test response latencies representing at least the amount of time between reception of answers for questions of the test instance.

62. The computer program product as recited in claim 61, wherein the one or more physical computer-readable media include system memory.

63. A computer program product for use at a proctor station configured to receive test registration and multimedia proctoring data associated with computerized test events, the computer program product for implementing a method for reviewing test registration and proctoring data for a computerized test event, the computer program product comprising one or more physical computer-readable media having stored thereon computer-executable instructions that, when executed by a processor, cause the testing station to perform the following:
receive pre-supplied test registration data for a test-taker;
receive user-entered test registration data entered by the test-taker at the remote testing station;
review at least a portion of the pre-supplied test registration data and at least a corresponding portion of the user-entered registration data to determine whether there is an increased risk of test-taker misconduct for the test event;
receive multimedia proctoring data, the multimedia proctoring data received at the proctor station continuously or in response to statistical analysis of test response data and test response latencies for the test event indicating that the test event has an increased risk of test-taker misconduct, the test response data representing answers to test questions presented during the test event, the test response latencies representing at least the amount of time between reception of answers to test questions included in the test event;
review at least a portion of the multimedia proctoring data to determine whether test-taker actions indicate an increased risk of test-taker misconduct; and
sending a message that indicates what is to be done with the results of the test event based on the information contained in the multimedia proctoring information, the message indicative of a human test proctor having reviewed the pre-supplied and user-entered registration and the multimedia proctoring data to confirm whether the test event was valid.

64. The computer program product as recited in claim 63, wherein the one or more physical computer-readable media include system memory.
